(19) United States
(12) Patent Application Publication
(10) Pub. No.: US 2003/0058274 A1
(43) Pub. Date: Mar. 27, 2003

(54) Interface device

(76) Inventors: Jake Hill, Ipswich (GB); Peter J. Onion, Colchester (GB)

Correspondence Address: NIXON & VANDERHYE P.C., 1100 North Glebe Road, 8th Floor, Arlington, VA, 22201, US

(21) Appl. No.: 09/805,376

(22) Filed: Mar. 14, 2001

(30) Foreign Application Priority Data
Nov. 17, 2000 (GB) 00310225.8

(51) Int. Cl. G06F 13/00

(52) U.S. Cl. 345/751

(57) ABSTRACT

The present invention relates to an interface device and, in particular an interface device for providing communication security services. The problem of providing communication security services to, for example, a pair of host computers that must communicate over an insecure public network is a widely addressed one. It is known to provide cryptographic functionality to a host computer such that data traffic transmitted by the host computer can be secured. However a major weakness of known methods is that such cryptographic processing is either carried out on the host or such that, following passing the data to be secured to an additional cryptographic accelerator device plugged into the host, the cryptographically processed data is passed back to the host before subsequent transmission. Both such methods give rise to a situation where, in the event of the host operating system being subverted, the original data and the cryptographically processed data are able to be simultaneously gathered on the host, giving rise to the classic “known plaintext” attack on the cryptographic key used in the encryption operation. According to the present invention however, an interface device is provided comprising a first interface for receiving data from a first zone in a first zone data format; means for processing said received data through performance of a cryptographic operation on at least a portion thereof; a second interface for sending said processed data to a second zone in a second zone data format; and means arranged to pass said processed data exclusively from said processing means to said second interface. In this way, in enforcing a unidirectional flow of information through the device and isolating all the necessary functionality (including, for example, the cryptographic key) on the device, the problems of the prior art are advantageously avoided.

The present invention relates to an interface device and, in particular an interface device for providing communication security services.

The problem of providing communication security services to, for example, a pair of host computers that must communicate over an insecure public network is a widely addressed one. Virtual Private Networks (VPNs; see, for example, “Virtual Private Networks”, Scott et al, O'Reilly & Associates Inc) are one example of a problem domain where secure communications between the potentially widely distributed computers of a given organisation are to take place over an unsecured public network, the leading example of which at the present time being the Internet.

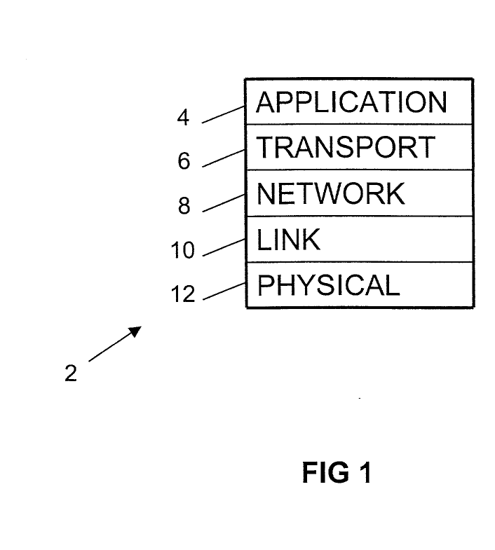

Having regard to FIG. 1 indicating a so-called “protocol stack” 2, whilst a variety of methods of providing communication security services over networks have been suggested which operate at application layer 4 or transport layer 6 of the network protocol stack, efforts have also been made to develop such methods which would operate at the network protocol layer 8.

In the context of the most widely utilised network layer protocol, the Internet Protocol (IP), the Internet Engineering Task Force (IETF) has now produced a plethora of Request For Comments (RFCs) documents on the subject of IP layer security. In particular, a new protocol, the Internet Security protocol (IPSec), is discussed in, for example, RFCs 1828, 1829, 2104, 2085, 2401, 2410, 2411, 2402, 2412, 2451, 2403, 2404, 2405, 2406, 2407, 2408, 2409 and 2857 (See the Webpages of the IPSec Working Group of the IETF).

RFC 2401, “Security Architecture for the Internet Protocol”, provides a useful overview of IPSec. The intention is to provide security at the IP layer for both Internet Protocol version 4 (lPv4) and its proposed successor, Internet Protocol version 6 (IPv6). Such security entails the use of authentication and encryption techniques as well as associated techniques such as key management. The new Authentication Header protocol (AH) provides the necessary authentication capability as discussed in

RFC 2402. The new Encapsulating Security Payload protocol (ESP) provides the necessary encryption capability as discussed in RFC 2406. The new Internet Key Exchange protocol (IKE) provides the necessary key exchange capability as discussed in RFC 2409.

IPSec communications can be secured in both “transport” and “tunnel” modes as discussed in RFC 2401. Transport mode is utilised for end-to-end security. Tunnel mode differs from transport mode in that the entire original IP packet is processed in accordance with the IPSec protocol and is encapsulated with new IP and IPSec headers (reflecting the tunnel destination IP address rather than the conventional original IP packet destination address).

RFC 2401 discusses a number of ways in which these IPSec protocols can be implemented. A first method modifies host native IP source code as to integrate IPSec into a native IP implementation. A second method is the so-called Bump In The Stack (BITS). BITS implements IPSec between a host native IP implementation and a local network driver.

Both the modification of the native IP source code and the BITS implementation have the disadvantage that the security of each IPSec implementation is compromised by the security of the host Operating System (OS). During the process of IPSec policy application, a cryptographic key may be utilised, for example, to carry out a suitable encryption operation. It might therefore be possible, in the absence of secure host process partitions, for a process unrelated to the IPSec functionality to obtain not only the unsecured packets (including, for example, plaintext) but also the corresponding IPSec secured packets (including, for example, the ciphertext resulting from the encryption operation).

Such a gathering of both the unencrypted plaintext and the resulting encrypted ciphertext provides the classic “known plaintext” attack on the cryptographic key used in the encryption operation (see, for example, p6, “Applied Cryptography”, Schneier, John Wiley & Sons, Inc.). If the cryptographic key can be obtained in this way then the security of the cryptosystem is fatally compromised.

Accordingly, for an Information Technology Security (ITSec) or similar security (CLEF) certification to be obtained for such implementations, the arduous securing of the host OS itself must be effected.

A further technique associated with a host utilises a “cryptographic coprocessor” to take the computational loading associated with IPSec cryptographic tasks. The concept of providing hardware accelerators on plug-in computer cards so that a host computer CPU can offload computationally intensive tasks to the hardware accelerator is well known. It is known, for example, for a Network Interface Card (NIC) to host this hardware accelerator functionality so that, in combination with suitable software running on a host into which the NIC is plugged, IPSec functionality can therefore be provided to a host computer. This approach may be considered a quasi-BITS IPSec implementation.

Given the necessary linkage with the bespoke driver software on the host however, this quasi-BITS IPSec implementation has the same disadvantage that the BITS approach has, which is to say that the security of the IPSec implementation is compromised by the security of the host OS. It might be possible, for example, for a process unrelated to the IPSec functionality to obtain not only the unsecured packets passed from the host to the NIC (including, for example, plaintext) but also the IPSec secured packets passed back from the NIC to the host (including, for example, ciphertext) thus again allowing an attack on the cryptographic key.

A third method is the so-called Bump In The Wire (BITW).

A conventional BITW device is deployed downstream of a host in a network link, for example with Ethernet in and Ethernet out, and accordingly entails the disadvantage that, between the host computer and the nearest BITW device the traffic is unsecured and is thus vulnerable.

In contrast to the techniques of the prior art, according to one aspect of the present invention, an interface device is provided comprising a first interface for receiving data from a first zone in a first zone data format; means for processing said received data through performance of a cryptographic operation on at least a portion thereof; a second interface for sending said processed data to a second zone in a second zone data format; and means arranged to pass said processed data exclusively from said processing means to said second interface.

Advantageously, following receipt of data at the first interface in the first data zone format and further following cryptographic processing of at least a portion of this data, this processed data is constrained to pass onward through the device to the second interface for subsequent transmission into the second data zone format (enforcing a unidirectional flow of information through the device). In this way, the device avoids a major weakness of the prior art where such processed data can be and indeed is, passed back by such a device to the zone (such as a host) from which it was received, giving rise to the aforementioned situation where both the data and the cryptographically processed data are able to be simultaneously gathered in the same zone (such as on the host). It is to be noted that this applies symmetrically to cryptographic operations such as both encryption and decryption.

Unlike the prior art, a device according to the invention provides all the necessary functionality to pass between the data formats of the first and second zones whilst carrying out the security related cryptographic operations inbetween. In this way all the necessary information (including, for example, the cryptographic key) for effecting the cryptographic operation is isolated on the device and hence is more secure than such information in techniques according to the prior art.

Preferably the device according to the invention further comprises means arranged to convert said received data in said first zone data format into at least one data format other than said first zone data format prior to said data processing.

Further advantageously, where appropriate, data can then be converted between different formats on the device (both up and down stack protocol layers), allowing data in the first format to be unwrapped to permit the one-way processing at a higher data format or protocol stack layer before subsequent wrapping of the processed data back down into a lower data format or protocol stack layer different from the first.

Further preferably the device according to the invention further comprises means arranged to transform the data format of said received data from said first zone at least twice prior to said data processing.

Yet further advantageously, this sequential data format transformation may provide for the establishment of a separate security zone on the device from that of at least one interface.

Yet further preferably, one of the first and second interfaces is suitable for connection to a host such that the data format utilised by such a connected interface is one utilised by the host.

Yet further advantageously, the interface device may then define a boundary between a host and a further zone such as a network, in which boundary cryptographic operation functionality is located to provide security to data traffic passing to and from the network.

According to another aspect of the present invention, an interface device is provided comprising a first interface for receiving data from a first authorised party in a first data format; means for processing said received data through performance of a computational operation on at least a portion thereof; a second interface for sending said processed data to a second authorised party in a second data format; means arranged to pass said processed data exclusively from said processing means to said second interface; wherein said operation performed by said processing means is such that if said sent processed data is intercepted by an unauthorised party, the recovery of said received data from said processed data is computationally unfeasible.

According to yet another aspect of the present invention, an equivalent method of operating an interface device is also provided.

A number of embodiments of the invention will now be described by way of example and with reference to the accompanying figures in which:

FIG. 1 represents a conventional protocol stack model;

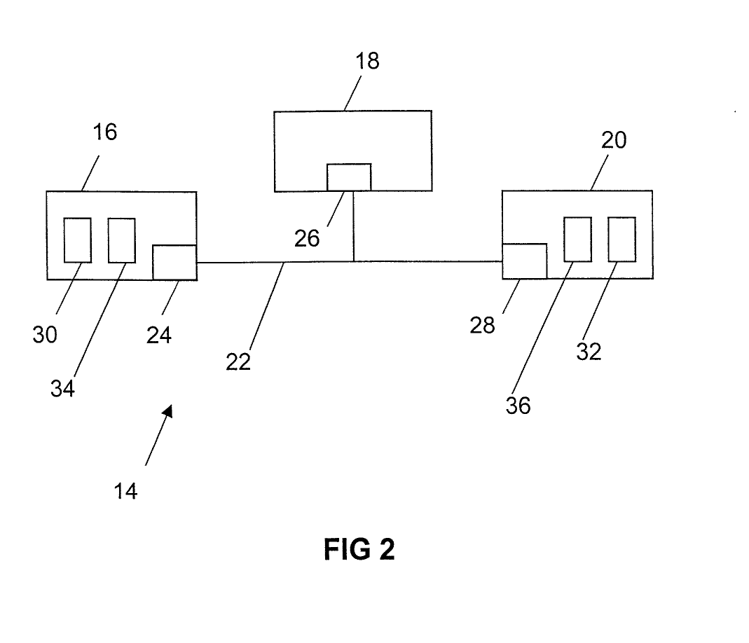

FIG. 2 represents a conventional LAN arrangement;

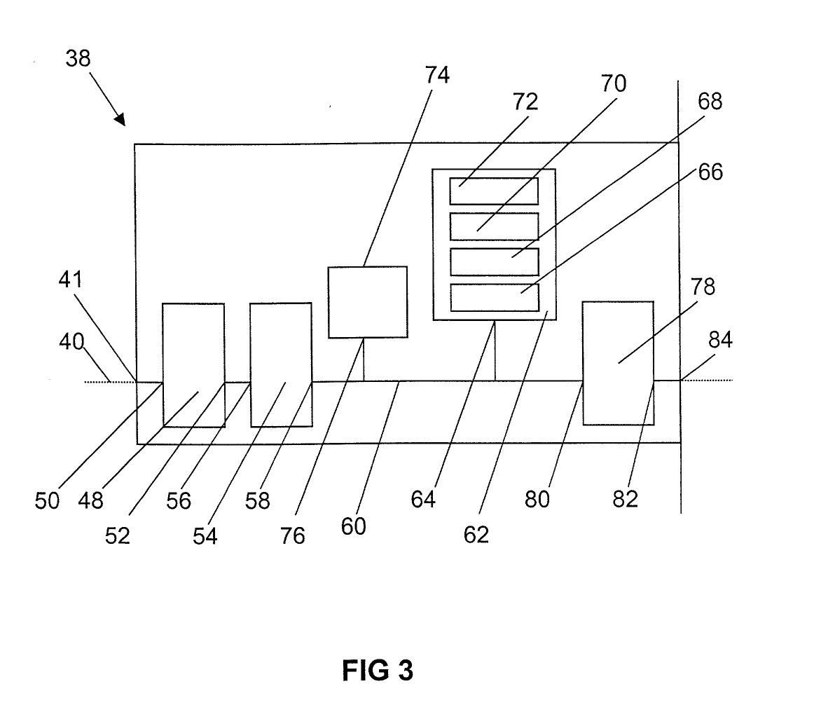

FIG. 3 represents a Network Interface Card (NIC) according to the invention;

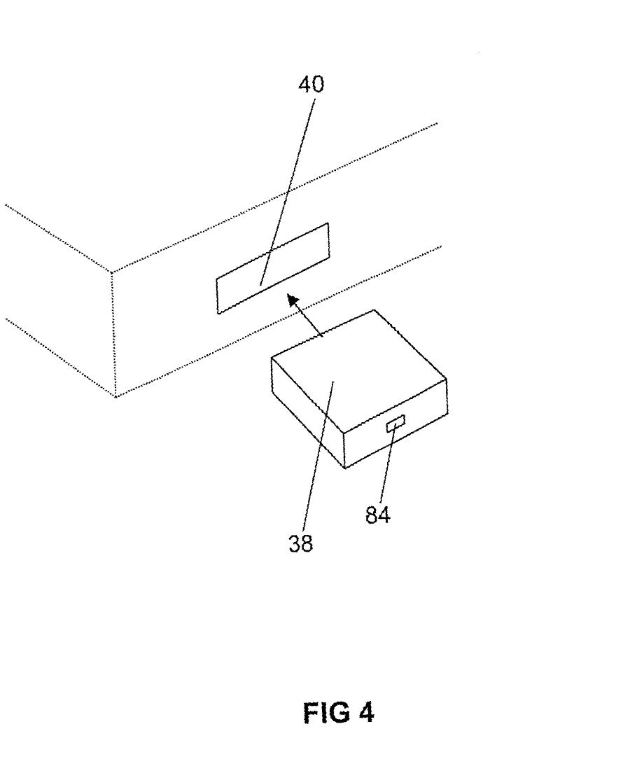

FIG. 4 represents a Network Interface Card (NIC) according to the invention;

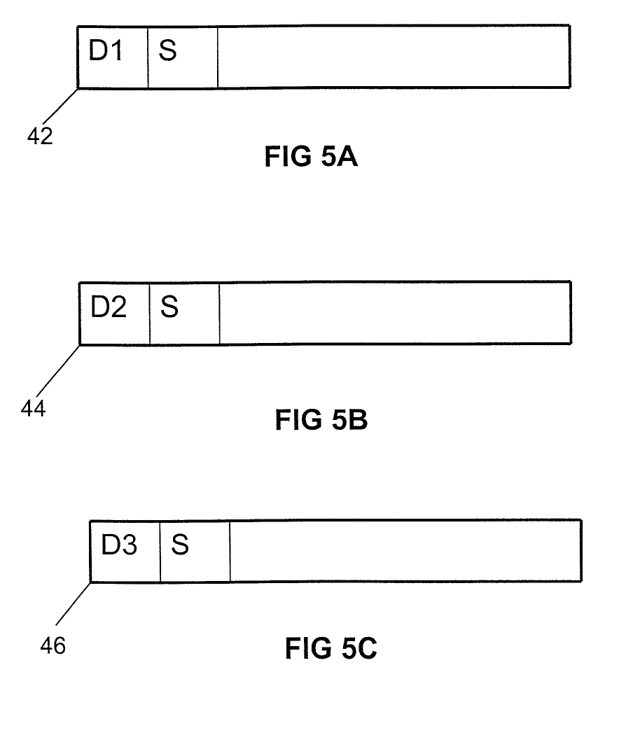

FIGS. 5A to 5C represent examples of packet data for processing according to the invention; and

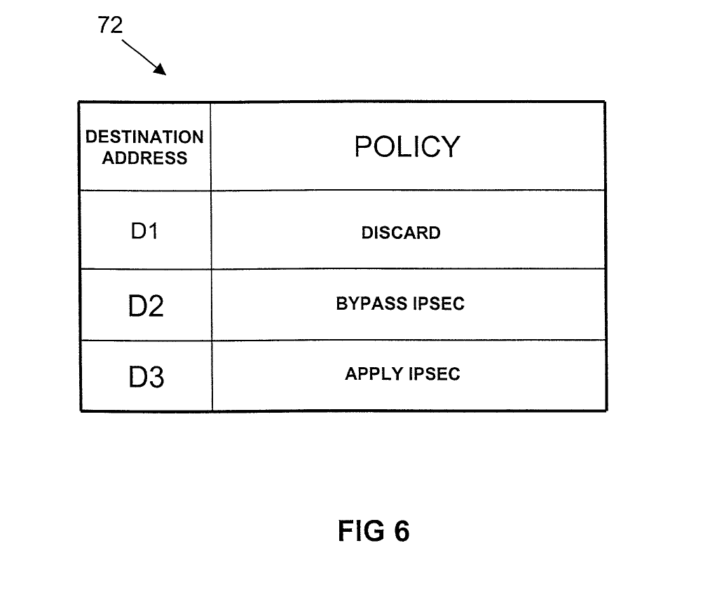

FIG. 6 represents a Security Policy Database (SPD); and

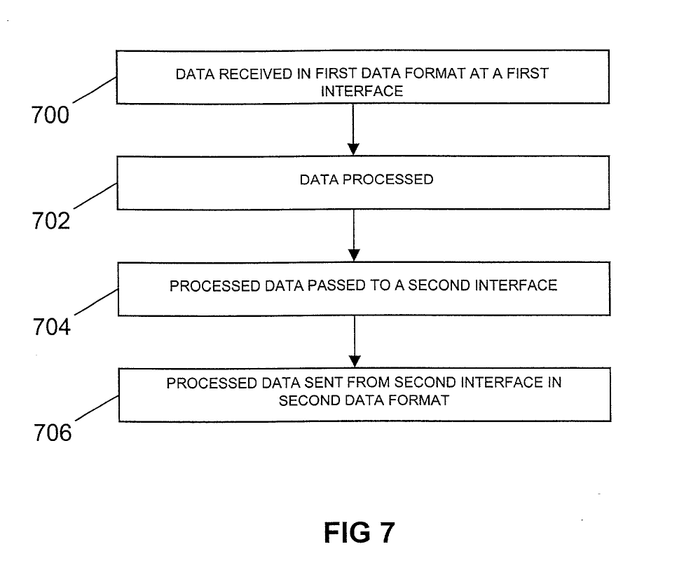

FIG. 7 is a flowchart representing a method according to the invention.

As indicated above, having regard to FIG. 1, the use of a so-called “protocol stack” 2 to describe the operation of application 4, transport 6, network 8, link 10 and physical layer 12 protocols will be well known (see for example Chapters 2 to 7 of “Computer Networks”, Tanenbaum, Prentice-Hall International Inc.).

FIG. 2 represents a conventional Local Area Network (LAN) arrangement 14.

Each of a number of host computers 16, 18, 20 are connected to a LAN 22 by means of respective Network Interface Cards (NIC) 24, 26, 28. An application program 30 running on a first host 16 may create data utilising a higher layer protocol that is to be sent over the LAN 22, utilising a link layer protocol, to a corresponding application 32 back at the higher layer protocol on a second host 20. One example of such an application 30 could be a web browser program such as Internet Explorer (Microsoft Inc.) on the first host creating HyperText Transfer Protocol (HTTP) requests which are sent over the network to a second, Web server, host for processing and return of HyperText Markup Language (HTML) files to the first host.

By way of illustration, the example of the carrying of data in the form of a set of IP packets over an Ethernet LAN will be discussed (See, for example, the Institute of Electrical and Electronics Engineers (IEEE) 802.3 standard and RFC 894, “A Standard for the transmission of IP Datagrams over Ethernet Networks”). In this example then, the data created by the first application program 30 takes the form of IP packets including both source and destination IP addresses. These IP packets are then passed to a first driver program 34 running on the first host 16 which in turn passes blocks of data representing the IP packets to the first NIC 24 (plugged into a suitable port of the first host).

This NIC 24 then utilises the Ethernet Medium Access Control protocol (MAC) to encapsulate each block of data in a suitable packet form to be sent over the LAN 22. For example, a NIC providing an interface to an Ethernet will attach a header (consisting of a 6 byte destination address, a 6 byte destination address and a 2 byte protocol type field) and a footer (consisting of a 4 byte Cyclic Redundancy Check) to each block of data prior to transmission.

When this packet is received by a corresponding NIC 28, plugged into a suitable port of the second host 20, the reverse process will occur. This second NIC 28 strips the MAC header and footer from each block of data and passes each block of data to a corresponding driver program 36 running on the second host 20. This second driver program 36 then recovers the respective IP packets in their original form and passes them to the appropriate application process 32 on the second host 20.

FIG. 3 represents a first embodiment of an interface device according to the invention taking the form of a Network Interface Card (NIC) 38. The data format at a first zone interface of the NIC is consequently an “internal” type, in this embodiment conforming to the Peripheral Component Interconnect (PCI) standard. The different data format at the other, second zone interface of the NIC is, of course, that of a network, in this embodiment conforming to the Ethernet standard.

It is to be noted that whilst the following discussion will first be directed to the processing of traffic originating at the host and heading for the network, the converse processing of traffic originating at a further host and heading from the network to the host takes place in the same fashion.

FIG. 4 illustrates the NIC 38 plugging in to a host port 40 conforming to the Peripheral Component Interconnect (PCI) standard.

Having regard to FIG. 2, the example of the carrying of IP traffic over an Ethernet will again be used. An application program 30 running on the first host 16 generates IP packets. By way of example and having regard to FIGS. 5A to 5C, first, second and third IP packets 42, 44, 46 with source address S and destination addresses D1, D2, D3 are considered. Once so generated these IP packets are passed “down the protocol stack” to a driver program 34. The driver program 34 then passes these IP packets as blocks of data to a host PCI bus 40.

Having regard to FIG. 3, as indicated above, the NIC 38 is plugged into a host port conforming to the PCI standard by means of a first physical connector 41 and hence is connected with the host PCI bus 40.

A first conventional network controller 48 is provided on the NIC 38, having a PCI interface 50 and an Ethernet interface 52. A second conventional network controller 54 is also provided in conventional form, having an Ethernet interface 56 and a PCI interface 58. One example of a suitable network controller is the AMD 79c973 Ethernet network controller (AMD Inc, One AMD Place, PO Box 3453, Sunnyvale, Calif. 94088). The PCI interface 50 of the first network controller 48 is connected to the host PCI bus 40. The first network controller 48 thus acts in conventional NIC fashion in providing an address on the NIC 38 to which the host driver may send. The blocks of data sent to the host PCI bus 40 are then picked up off this host PCI bus 40 by the first network controller 48 on the NIC 38.

The first network controller 48 wraps each received block of data in the MAC protocol format to produce an Ethernet compliant packet as discussed above. These Ethernet compliant packets are then sent out from the Ethernet interface 52 of the first network controller 48.

In this first embodiment however a trivial first Ethernet is provided in that the Ethernet interface 56 of the second network controller 54 is directly connected to the Ethernet interface 52 of the first network controller 48. Accordingly, the second network controller 54, unwraps the Ethernet compliant packet and removes the MAC protocol format added to the received data by the first network controller 48 to reproduce the received data alone. The purpose of these back-to-back first and second network controllers 48, 54 will be discussed further below.

This received data is then passed from the PCI interface 58 of the second network controller 54 to a local NIC PCI bus 60.

This local NIC PCI bus 60 is also connected with an Embedded Personal Computer (EPC) 62 by means of a PCI interface 64. One example of a suitable EPC is the AMD SC520 (AMD Inc, One AMD Place, PO Box 3453, Sunnyvale, Calif. 94088) although it will be appreciated that many such devices based on, for example, the Intel x86 or PPC families provide “PCs on a chip”. It will be appreciated that conventional support hardware for the EPC such as memory modules is not illustrated.

One example of a suitable Operating System (OS) 66 for the EPC 62 is Linux (typically a small Linux distribution suitable for embedded applications such as Alfalinux).

A driver program 68 is also provided on the EPC 62. In this way, the IP packets generated on the host 16 can be recovered on the EPC 62 and passed to application programs running thereon.

One example of a suitable application program 70 to be executed on the EPC 62 to provide IPSec functionality (as discussed above in the context of RFC 2401) is Linux Free S/WAN (Free S/WAN has been developed by an Open Source team founded by John Gilmore; it is to be noted that Free S/WAN derives its name from S/WAN, Secure Wide Area Network which is a trademark in the USA of RSA Data Security Inc). Linux Free S/WAN provides implementation for both IPSec and Internet Key Exchange (IKE) for the Linux operating system.

The EPC 62 is also provided with a Security Policy Database (SPD) 72 which provides information as to IPSec policies and the necessary circumstances for their respective application as will be discussed further below.

A cryptographic accelerator 74 having a PCI interface 76 is also provided on the NIC 38. One example of a suitable cryptographic accelerator is the Hi/fn 7951 (Hi/fn Inc, Los Gatos, Calif.). By way of modification of the Free S/WAN application software, the EPC 62 is arranged to communicate with the cryptographic accelerator 74 over the local PCI bus 60 under the control of the application program 70 such that the computationally intensive processes involved such as performing a hash operation or an encryption operation are carried out in the optimised accelerator hardware. Further to the discussion above, a general discussion of both the theory and practice of such operations can be found in “Applied Cryptography”, Bruce Schneier, John Wiley & Sons Inc.

FIG. 6 provides a schematic illustration of the entries in the SPD 72. By way of example, the three different IPSec security policy choices (discard, bypass IPSec application and apply IPSec) are to be illustrated as applied to the first, second and third IP packets 42, 44, 46. The first two of these policies are discussed merely by way of completeness of IPSec functionality; it is to be noted that only one or two, or all three policies may be provided for as differing fields of application demand (e.g. it may be appropriate in a VPN application to provide only “discard” and “apply IPSec” so that dual membership of a VPN and a non-VPN (an ordinary “bypass IPSec” network) is forbidden).

If application of IPSec is mandated then the SPD 72 is further consulted for the relevant Security Association (SA) (not shown) providing the IPSec processing parameters. If such an SA does not exist in the SPD for a given case, then the relevant packet may be queued until, utilising the IKE protocol, an appropriate SA is negotiated with a destination computer. It is to be noted that a more detailed discussion of the process of IPSec policy application including SAs and the use of IKE is provided in RFCs 2401 and 2409.

In respect of the first packet 42, in a first step, the application program 70 determines the first destination IP address, Dl, from the IP header. In a second step, application program 70 consults the SPD 72 as to which policy is to be applied to IP packets sent to address Dl, which in this example, is “discard”. This first policy choice applies, for example, when traffic is not to be allowed to exit a host. In a third step, this policy is applied and the first packet 42 discarded.

In respect of the second packet 44, in a first step, the application program determines the second destination IP address, D2, from the IP header. In a second step, the SPD 72 is consulted as to which policy is to be applied to IP packets sent to address D2, which in this example, is “bypass IPSec”. This second policy choice applies, for example, when traffic is to be allowed to exit a host in conventional fashion, which is to say, without any IPSec protection. In this way, the “bypass IPSec” policy reduces to conventional NIC functionality. In a third step, this policy is applied and, in a fourth step, the unaltered second packet 44 is passed to the driver program 68.

In respect of the third packet 46, in a first step, the application program determines the third destination IP address, D3, from the IP header. In a second step, the SPD 72 is consulted as to which policy is to be applied to IP packets sent to address D3, which in this example, is “apply IPSec”. This third policy choice applies, for example, when traffic is only to be allowed to exit a host or be delivered to a host following IPSec processing and must specify the corresponding SA processing parameters, for example, security services to be provided, protocols to be utilised and algorithms to be employed. In a third step, this policy is applied and the third packet 42 is processed accordingly. In a fourth step, the altered third packet 46 (for example with AH or ESP) is also passed to the driver program 68.

The driver program 68 executed on the NIC 38 provides additional functionality to that provided by the host driver program in that support is provided for these extra IPSec fields in the IPSec processed packets.

As indicated above, it is essential for the processed packets to pass out of the device through the other interface from that on which the packets were originally received. In this embodiment the respective packets 42, 44, 46 were received from the host side at the first network controller 48. The processed packets must therefore pass out from the device to the network side. Accordingly, the driver 68 in turn passes them as blocks of data over the local PCI bus 60 to a third conventional network controller 78 by means of a PCI interface 80. The unique address of the third network controller 78 on the local PCI bus 60 thus provides for an exclusive passing of the processed data from the EPC 62 to the network facing third network controller 78. Again, one example of a suitable network controller is the AMD 79c973 Ethernet network controller, (AMD Inc, One AMD Place, PO Box 3453, Sunnyvale, Calif. 94088). In the same manner as the first network controller 48, the third network controller 78 acts in conventional NIC fashion in wrapping these newly received blocks of data in the MAC protocol format to produce an Ethernet compliant packet.

This Ethernet compliant packet will then pass out through the Ethernet interface 82 and, via a physical Ethernet connector 84, onto the Ethernet.

The Ethernet compliant packet will then be picked up by a second NIC according to the invention plugged in to a second host. The process outlined above will be carried out in reverse until the relevant IP packets have been delivered to the corresponding application program on the second host.

It is to be noted that, in the example utilised above, the first packet 42 would never be transmitted onto the Ethernet, the second packet 44 would be transmitted via the Ethernet to the second NIC but in unsecured form (as if the NIC 38 according to the invention were merely an ordinary NIC 24), whilst the third packet 46 would be transmitted via the Ethernet to the second NIC in IPSec secured form (with, for example, AH or ESP as indicated above).

The first embodiment of the invention as described in relation to FIGS. 3 and 4 provides significant advantages over the conventional BITS, quasi-BITS and conventional BITW approaches.

With the device according to the invention the IPSec policy application process is entirely transparent to a host into which the device is plugged. As far as the host is concerned, the NIC according to this embodiment of the invention presents just the same interface as any other NIC (in this embodiment, the PCI interface of the first network interface device). All the functionality associated with IPSec is isolated on the NIC. Since there is no functional linkage between the host and the NIC beyond the conventional NIC driver, no such bespoke driver programs are needed on the host as introduced the security flaw of the methods according to the prior art.

Accordingly, with the method according to this embodiment it is no longer possible to make the attack on the cryptographic key that the weakness of the prior art methods allowed. Even if a host is compromised such that a host process unrelated to the IPSec functionality can obtain the unsecured packets passed from the host to the NIC, there are no longer any IPSec secured packets passed back from the NIC to the host. All such IPSec secured packets pass only onward through the NIC and onto the network. In this way the rogue host process can never have access to both plaintext and ciphertext as occurred in methods according to the prior art. Furthermore, all the information relating to the cryptographic key material utilised in the cryptographic operation is isolated on the device and hence is more secure than such information in techniques according to the prior art where a rogue host process might have had access thereto.

In similar fashion, the device according to this embodiment avoids a situation where, were IPSec secured packets received by a device according to the prior art, processed as to remove the IPSec protection and then the (newly) unsecured packets passed back to the zone from whence they were received, the same attack could be mounted, i.e. the concern applies symmetrically to both transmission and receipt.

In this way, ITSec or similar security (CLEF) certification can be effected in respect of the device alone.

A further advantage of this transparency of the NIC to the host machine is that the NIC device according to the invention is inherently multi-platform. Any OS capable of driving such an ordinary NIC as the NIC according to this embodiment appears to be, will be capable of driving the NIC according to this embodiment.

A method for creating and administering the SPD 72 on the NIC 38 must be provided. Having regard to the embodiment illustrated in FIGS. 3 and 4, an administrator is allowed to effect amendment to the SPD 72 utilising, for example, Simple Network Management Protocol (SNMP) compliant packets (See, for example, p630, “Computer Networks”, Tanenbaum, Prentice-Hall International Inc.). Such an administrator could, for example, be utilising a further host connected to the network such as the third host 18 in FIG. 2. In this way, the application program 70 is modified to act on the contents of SNMP packets to effect amendment to the SPD 72. By way of example and having regard to FIG. 6, an SNMP packet could provide for a change in the SPD 72 such that IPSec policies are to be applied in respect of destination address D2 (hence “apply IPSec” replaces “bypass IPSec” in the SPD 72 D2 entry) in the same manner as D3.

It will be appreciated that further advantage is provided in terms of security in that only such SNMP packets originating with the administrator may be recognised as authorised control messages. Accordingly, a further advantage of this transparency of the NIC to the host machine is that a user of the host machine can have no access to the NIC SPD and cannot therefore amend the policies to be implemented.

A further security advantage of this embodiment according to the invention is that the first and second network interface devices 48, 54 (back-to-back Ethernet chips) provide a separation of the host PCI bus 40 and the NIC PCI bus 60 into two discrete zones for security purposes (i.e. two distinct PCI zones separated by an Ethernet zone). These first and second network interface devices 48, 54 are not essential for the operation of the invention however.

In alternative embodiments, the first and second network interface devices could be modified in a number of ways. Whilst the first network interface device might interface between, for example, a first and second data format such as PCI and Ethernet data formats, the second network interface device might interface between this second data format such as Ethernet and a third data format. The internal NIC PCI bus of this embodiment would instead take the form of an internal bus operating with this third data format. In this way, the discrete security zoning advantage of the illustrated embodiment would again be provided. Alternatively, the first and second network interface devices could be replaced by a single device (for example, a suitably programmed Field Programmable Gate Array device (FPGA)) or a process running on the EPC allowing a masquerade as an ordinary PCI device or PCI bus interconnection and thereby providing an address on the device to which host PCI data could be sent.

Further, in an alternative embodiment, the EPC 62 could utilise a second PCI interface in communicating with the cryptographic accelerator 74 over a second NIC PCI bus, separate from the first NIC PCI bus. Advantageously, in this way, the cryptographic coprocessor would be separated from other devices having access to the first NIC PCI bus.

A further security advantage of this first embodiment of an interface device according to the invention relates to tamperproofing. The device can be embodied with the small form factor of a Network Interface Card (NIC) to allow for insertion into a host port or other such suitable slot such that the device is more difficult to access than might be the case with a stand-alone box. For dedicated applications the device could be sealed inside the host in tamperproof fashion.

A flowchart indicating method steps according to the invention is illustrated in FIG. 7. In a first step 700, data is received in a first data format at a first device interface.

In a second step 702, at least a portion of this data is processed with a cryptographic function. In a third step 704, this processed data is passed exclusively to a second device interface. In a fourth step 706, this processed data is sent from the second device interface in a second data format.

More generally than the embodiments illustrated in FIGS. 3, 4 and 7, where communication is to be provided over an insecure network between, for example, the host computers of a pair of authorised parties (where such authorised parties are accorded the functionality associated with the invention) the processing carried out according to the invention is such that, in the event that the processed data is (covertly) intercepted by an unauthorised party, the recovery of the original data (i.e. the data form before such processing) from the processed data is computationally unfeasible.

Such an operation may therefore be understood as one indicating the property that, given x, y=f(x) is trivial to compute but given y, x is computationally unfeasible to recover by an unauthorised party, either in absolute terms (including for example a hash operation) or without further information (including for example the cryptographic key for the process of decrpytion) known only to the authorised parties. A more complete discussion of such operations is to be found in, for example, “Codes and Cryptography”, Dominic Welsh, Clarendon Press, Oxford.

Although the illustrated device embodiment utilised PCI and Ethernet data formats, a device according to the invention is by no means limited to such a PCI and Ethernet pair of data formats. Any two differing data formats could be utilised.

A device according to the invention could be embodied for example as a Personal Computer Memory Card International Association (PCMCIA) standard card, as a plug-in module for a mobile phone or other terminal such as a wireless communications enabled Personal Digital Assistant (PDA), or, for example, with optical or logical interfaces.

As indicated above, suitable applications for devices according to the invention include secure VPNs. In this way, new host devices can be added in transparent fashion (without any modification to the host software) merely by plugging a card or similar interface device according to the invention.

1. An interface device comprising:
a first interface for receiving data from a first zone in a first zone data format;
means for processing said received data through performance of a cryptographic operation on at least a portion thereof;
a second interface for sending said processed data to a second zone in a second zone data format; and
means arranged to pass said processed data exclusively from said processing means to said second interface:

2. An interface device as claimed in claim 1 further comprising:
means arranged to convert said received data in said first zone data format into at least one data format other than said first zone data format prior to said data processing.

3. An interface device as claimed in claim 1 or claim 2 further comprising:
means arranged to transform the data format of said received data from said first zone at least twice prior to said data processing.

4. An interface device as claimed in any preceding claim in which said first zone data format is packetised data, further comprising:
means for reading at least one item of identification data from each packet;
wherein
said processing means is arranged to process each respective packet in dependence on the or each corresponding item of identification data.

5. An interface device as claimed in claim 4 further comprising:
a store for storing one or more rules, each rule being linked with at least one of item of identification data; wherein
said processing means is arranged to process each packet in dependence upon the rule linked with the corresponding item(s) of identification data.

6. An interface device as claimed in any preceding claim wherein one of the first and second interfaces is suitable for connection to a host such that the data format utilised by such a connected interface is one utilised by the host.

7. An interface device as claimed in claim 6 when depending on claim 5 in which, in response to receiving at least one control packet including at least an item of control identification data and control instructions through the interface not connected to the host and reading said item of control identification data from a control packet, said processing means is arranged to change said rules in said store in dependence upon said corresponding control instructions.

8. An interface device comprising:
a first interface for receiving data from a first authorised party in a first data format;
means for processing said received data through performance of a computational operation on at least a portion thereof;
a second interface for sending said processed data to a second authorised party in a second data format;
means arranged to pass said processed data exclusively from said processing means to said second interface;
wherein said operation performed by said processing means is such that if said sent processed data is intercepted by an unauthorised party, the recovery of said received data from said processed data is computationally unfeasible.

9. A method of operating an interface device comprising:
receiving data at a first interface from a first zone in a first zone data format;
processing said received data through performance of a cryptographic operation on at least a portion thereof;
passing said processed data exclusively from said processing means to a second interface; and
sending said processed data from said second interface to a second zone in a second zone data format.

10. A method of operating an interface device as claimed in claim 9 further comprising:
converting said received data in said first zone data format into at least one further data format prior to said processing.

11. A method of operating an interface device as claimed in claim 9 or claim 10 further comprising transforming the data format of said received data from said first zone at least twice prior to said processing.

12. A method of operating an interface device comprising:
receiving data at a first interface from a first authorised party in a first data format;
processing said received data through performance of a computational operation on at least a portion thereof;
passing said processed data exclusively to a second interface;
sending said processed data from said second interface to a second authorised party in a second data format;
wherein said performance of said computational operation is such that if said sent processed data is intercepted by an unauthorised party, the recovery of said received data from said processed data is computationally unfeasible.
